(19) United States
(12) Patent Application Publication
(10) Pub. No.: US 2004/0127185 A1
(43) Pub. Date: Jul. 1, 2004

(54) Harmonic suppression for a multi-band transmitter

(76) Inventors: Richard L. Abrahams, Satellite Beach, FL (US); R. Douglas Schultz, Melbourne, FL (US); Adam K. Harriman, Palm Bay, FL (US); W. Joseph Vitek IV, Penacook, NH (US)

Correspondence Address: GARY R. STANFORD, 610 WEST LYNN, AUSTIN, TX, 78703, US

(21) Appl. No.: 10/735,012

(22) Filed: Dec. 12, 2003

Related U.S. Application Data
(60) Provisional application No. 60/436,061, filed on Dec. 23, 2002.
(60) Provisional application No. 60/438,829, filed on Jan. 9, 2003.

(51) Int. Cl. H04B 1/06; H04B 7/00

(52) U.S. Cl. 455/277.1; 455/552.1

(57) ABSTRACT

A multiple band transmitter including first and second transmit amplifier paths, where the first transmit amplifier path conducts a first transmit signal at a first frequency band and the second transmit amplifier path conducts a second transmit signal at a second frequency band. The second transmit amplifier path includes an amplifier that generates the second transmit signal along with a harmonic frequency within a passband of the first transmit amplifier path. The second transmit amplifier path further includes a trap circuit that shunts the harmonic frequency away from the first transmit amplifier path.

### CROSS-REFERENCE TO RELATED APPLICATIONS

This application claims the benefit of U.S. Provisional Application No. 60/436,061 filed on Dec. 20, 2002, entitled “HARMONIC SUPPRESSION FOR A MULTI-BAND TRANSMITTER” (ATTY Docket No. INSL:0072P), and claims the benefit of U.S. Provisional Application No. 60/438,829 filed on Jan. 9, 2003, entitled “HARMONIC SUPPRESSION FOR A MULTI-BAND TRANSMITTER” (ATTY Docket No. INSL:0072P2), both of which are herein incorporated by reference for all intents and purposes.

### BACKGROUND OF THE INVENTION

1. Field of the Invention

The present invention relates to suppression of harmonic energy, and more particularly to suppressing harmonic energy from a power amplifier of one transmission path to prevent coupling into another transmission path and to enable compliance with harmonic specifications.

2. Description of the Related Art

The Institute of Electrical and Electronics Engineers, Inc. (IEEE) 802.11 standard is a family of standards for wireless local area networks (WLAN) in the unlicensed 2.4 and 5 Gigahertz (GHz) bands. The current IEEE 802.11b standard (also known as “Wi-Fi”) defines various data rates in the 2.45 GHz band, including data rates of 1, 2, 5.5 and 11 Megabits per second (Mbps). The 802.11b standard defines single-carrier packets using a serial modulation technique and direct sequence spread spectrum (DSSS) with a chip rate of 11 Megahertz (MHz). The IEEE 802.11a standard defines multi-carrier packets with data rates of 6, 12, 18, 24, 36 and 54 Mbps in the 5 GHz band using an orthogonal frequency division multiplexing (OFDM) encoding method. The 802.11b standard has been relatively popular for many WLAN configurations and has been widely disseminated. It was thought that WLANs employing 802.11a, providing significantly higher throughput data rates, would replace those based on the 802.11b standard. For various reasons, including cost and performance factors, the 802.11a standard has not been adopted as quickly as thought. It is noted that systems implemented strictly according to either the 802.11a standard or the 802.11b standard are incompatible and not designed to work together.

A new IEEE standard is being proposed, referred to as 802.11g (the “802.11g draft standard”), which is a high data rate extension of the 802.11b standard at 2.4 GHz. It is desired that devices implemented according to the 802.11g draft standard be backwards compatible with 802.11b devices and operate in the 2.45 GHz band. In accordance with a current draft of 802.11g, in fact, 802.11g devices should be configured to fully support communications according to 802.11b and be able to communicate at any of the standard 802.11b rates. It is also desired, however, that the 802.11g devices be able to communicate at higher data rates, such as the same data rates supported by the 802.11a standard. The higher data rates are achieved by borrowing encoding and modulation techniques of 802.11a and applying them in the 2.4 GHz band. The current 802.11g standard includes several higher data rate modes, including a mandatory mode and two optional modes. The mandatory mode employs 802.11a-type packets using OFDM in the 2.45 GHz band.

Some have proposed dual-band radios that support the 802.11a standard at 5 GHz and either or both of the 802.11b and 802.11g standards at 2.45 GHz. For various reasons, including radio cost and size constraints, it is desired that both bands utilize the same antenna. To achieve the desired levels of output power, separate output power amplifiers and transmission paths are needed to amplify and convey transmit data for each frequency band to separate inputs of a diplexer having an output coupled to a common dual band antenna. The output power amplifiers tend to generate non-linear distortion so that significant levels of harmonic energy is radiated at their outputs. This harmonic energy is particularly problematic given that the second harmonic of the 2.45 GHz band (e.g., approximately 4.9 GHz) is within an interfering frequency range of the second 5 GHz band. Although separate low pass filters may be employed for each transmit path to prevent undesired harmonics from an active transmit path from being directly conveyed to the diplexer, any harmonic energy from the 2.45 GHz transmission path coupled into the 5 GHz transmission path is passed with very low loss. For example, any second harmonic energy of the 2.45 GHz signal coupled into the 5 GHz path will also pass through the diplexer to the antenna causing the radio to fail necessary compliance harmonic specifications promulgated in the U.S. by the Federal Communications Commission (FCC) and internationally by the European Telecommunications Standards Institute (ETSI).

Several techniques are known that may be employed in an attempt to electrically isolate the power amplifiers and transmission paths to prevent harmonic energy coupling between the two transmission paths. Separate and isolated power supplies may be used along with separate shielded enclosures for physical isolation of the power amplifiers. The transmission paths may be physically separated and further electrically isolated using known circuit isolation techniques. These known isolation techniques are difficult to implement, pose severe design constraints and add a significant amount of cost. For example, it is very difficult to achieve physical and electrical isolation at the diplexer inputs. In certain configurations, it may be difficult to sufficiently separate the power amplifiers, resulting in finite coupling between the two power amplifiers and transmission paths which severely limits the options for harmonic energy suppression.

Although the present invention is illustrated in the field of WLAN dual band communications, the same technical challenges exist for amplification and transmission of multi-band high frequency signals, particularly when any harmonic energy of one band is relatively close to another band. It is desired to provide a multi-band band transmitter that meets harmonic compliance requirements. It is desired to be able to build and design such radios with as few design constraints as possible and as cost-effective as possible.

### SUMMARY OF THE INVENTION

A multiple band transmitter according to an embodiment of the present invention includes first and second transmit amplifier paths, where the first transmit amplifier path conducts a first transmit signal at a first frequency band and the second transmit amplifier path conducts a second transmit signal at a second frequency band. The second transmit amplifier path includes an amplifier that generates the second transmit signal along with a harmonic frequency within a passband of the first transmit amplifier path. The second transmit amplifier path further includes a trap circuit that shunts the harmonic frequency away from the first transmit amplifier path.

In one embodiment, the trap circuit is a series LC circuit. In a more specific embodiment, the series LC circuit is tuned to a second harmonic frequency of the second frequency band. The series LC circuit may present a load that cooperates with remaining portions of the second transmit amplifier path to optimize power throughput of the second transmit signal along the second transmit amplifier path.

In an alternative embodiment, the trap circuit is a transmission line. In a more specific embodiment, the transmission line is tuned to a second harmonic frequency of the second frequency band. The transmission line may be configured to have a length which is approximately one-half the wavelength of a second harmonic frequency of the second frequency band.

A multiple band transmitter according to another embodiment of the present invention includes a plurality of amplifier paths, each amplifying a corresponding transmit signal at a corresponding frequency band. The amplifier paths include a first amplifier path that generates a harmonic frequency within a passband of at least one other amplifier path. The first amplifier path includes a trap circuit that shunts the harmonic frequency to ground.

In various embodiments, the trap circuit is a series LC circuit or a transmission line or the like. The first amplifier path may include a power amplifier having an output that generates the harmonic frequency. The trap circuit may be coupled at an output of the power amplifier.

### BRIEF DESCRIPTION OF THE DRAWINGS

The benefits, features, and advantages of the present invention will become better understood with regard to the following description, and accompanying drawings where:

FIG. 1 is a simplified schematic diagram of a portion of a dual band wireless transmitter implemented according to an exemplary embodiment of the present invention using an LC trap circuit; and

FIG. 2 is a simplified schematic diagram of a portion of a dual band wireless transmitter implemented according to an alternative embodiment of the present invention using a transmission line trap circuit.

### DETAILED DESCRIPTION

The following description is presented to enable one of ordinary skill in the art to make and use the present invention as provided within the context of a particular application and its requirements. Various modifications to the preferred embodiment will, however, be apparent to one skilled in the art, and the general principles defined herein may be applied to other embodiments. Therefore, the present invention is not intended to be limited to the particular embodiments shown and described herein, but is to be accorded the widest scope consistent with the principles and novel features herein disclosed.

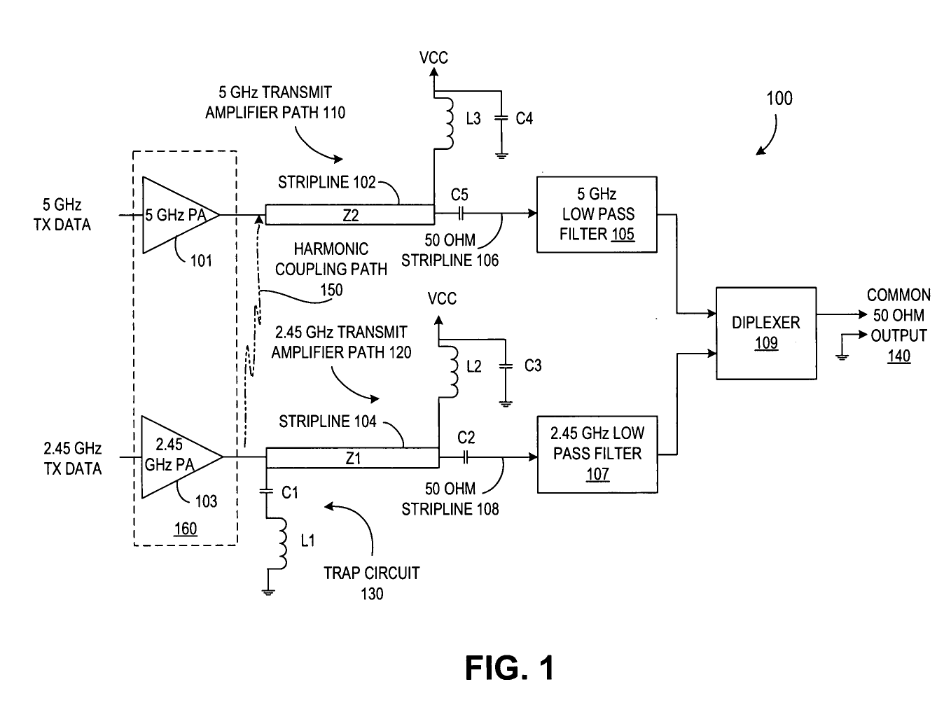

FIG. 1 is a simplified schematic diagram of a portion of a dual band wireless transmitter 100 implemented according to an exemplary embodiment of the present invention. In the embodiment shown, the transmitter 100 is part of a wireless transceiver used to enable wireless communications according to selected one or more of the 802.11 standards. The transceiver may be implemented on any desired platform, such as a plug-in peripheral or expansion card that plugs into an appropriate slot or interface of a computer system, such as a Personal Computer Memory Card International Association (PCMCIA) card or PC Card or the like, or may be implemented according to any type of expansion or peripheral standard, such as according to the peripheral component interconnect (PCI), the Industry Standard Architecture (ISA), etc., implementing a radio network interface card (NIC). Mini PCI cards with an antenna embedded in a display is also contemplated. Self-contained or standalone packaging with appropriate communication interface(s) is also contemplated, which is particularly advantageous for Access Points (APs) or the like. The transceiver may be implemented as a separate unit with serial or parallel connections, such as a Universal Serial Bus (USB) connection or an Ethernet interface (twisted-pair, coaxial cable, etc.), or any other suitable interface to the device. Other types of wireless devices are contemplated, such as any type of wireless telephony device including cellular phones.

The transceiver communicates via the wireless medium using at least one antenna (not shown) coupled via a common 50 ohm output 140. The transceiver includes a radio which converts between radio frequency (RF) signals and Baseband signals. In a typical 802.11 configuration, the radio is coupled to a baseband processor (not shown), which is further coupled to a medium access control (MAC) device (not shown). The MAC device communicates with the associated or underlying communication device or system. Digital data sent from or received by the transceiver is processed through the MAC. The receiver portion of the transceiver is not applicable and not further described. For transmission, the MAC asserts digital data signals to baseband processor, which formulates data into packets for transmission. The digital packet information is converted to analog signals using a digital to analog converter (DAC) (not shown) and processed by the radio to convert the packets into RF signals suitable for transmission via the antenna. The illustrated portion of the transmitter 100 represents the final stage of a dual-band transceiver, in which the RF signals are amplified for transmission in the wireless medium via the antenna.

Although the present invention is illustrated in the field of WLAN dual-band communications, it is understood that the present invention applies to any multi-band frequency communication system that amplifies and transmits information in multiple frequency bands. The production and radiation of harmonic energy is particularly problematic in higher frequency applications (e.g., ˜1 GHz or more), in which the frequency and speed limitations of the power amplifiers tend to cause greater levels of harmonic energy. It is understood that the specific 2.45 GHz and 5 GHz bands are exemplary only and that any frequency bands are contemplated in which a harmonic of a first band is within an interfering frequency range of a second band or within the pass band (or, as used herein, “passband”) of a transmit path of the second band. Further, the present invention is illustrated for the case in which a second frequency band is approximately twice the first so that the second harmonic of the first band is within interfering frequency range of the second. It is understood, however, that the suppression of other harmonic energy (e.g., 3rd harmonic, 4^{th} harmonic, etc.) is contemplated based on the relative frequency levels of the relevant bands. For example, suppression of a third harmonic of a first band is contemplated where the transmitter includes a second band or third band at three times the frequency level of the first band.

The transmitter 100 includes two transmitter amplifier paths, including a 5 GHz band transmit amplifier path 110 and a 2.45 GHz band transmit amplifier path 120. In the 5 GHz transmit amplifier path 110, the radio provides 5 GHz transmit (TX) data to the input of a 5 GHz power amplifier (PA) 101, having its output coupled to one end of a stripline 102 having an impedance value Z2. The other end of the stripline 102 is coupled to one end of an inductor L3 and to one end of a coupling or “feed through” capacitor C5. The other end of the inductor L3 is coupled to a DC power supply signal VCC. A bypass capacitor C4 is coupled between VCC and ground. The other end of the capacitor C5 is coupled to the input of a 5 GHz low pass filter (LPF) 105 via 50 ohm stripline 106. The output of the LPF 105 is coupled to one input of a diplexer 109. The output of the diplexer 109 is the common 50 ohm output 140, which is coupled to the antenna.

In the 2.45 GHz transmit amplifier path 120, the radio provides 2.45 GHZ transmit (TX) data to the input of a 2.45 GHZ PA 103, having its output coupled to one end of a stripline 104 and to one end of a capacitor C1. The other end of the capacitor C1 is coupled to one end of an inductor L1, having its other end coupled to ground. The capacitor C1 and the inductor L1 form a trap circuit 130, described further below. The stripline 104, having an impedance value Z1, has its other coupled to one end of an inductor L2 and to one end of a coupling or feed through capacitor C2. The other end of the inductor L2 is coupled to VCC. A bypass capacitor C3 is coupled between VCC and ground. The other end of the capacitor C2 is coupled to the input of a 2.45 GHz LPF 107 via 50 ohm stripline 108. The output of the LPF 107 is coupled to another input of the diplexer 109. In this manner, the 5 GHz transmit amplifier path 110 and the 2.45 GHz transmit amplifier path 120 share the common 50 ohm output 140 and the same antenna via the diplexer 109.

In the 5 GHz transmit amplifier path 110, the signal to be transmitted is output from the 5 GHz PA 101 onto stripline 102. In one embodiment, the stripline 102 is a circuit trace configuration including a signal trace and a pair of ground traces on either side to shield and conduct the signal. This stripline 102 acts as a transmission line with associated complex impedances, as can be understood by one skilled in the art. The length, width, size and spacing of associated signal and ground shield traces combine to create the complex impedance Z2. The values of the complex impedance Z2 of the stripline 102, the inductance of the inductor L3, and the capacitance of the capacitor C4 combine to provide desired impedance loading for the output of the 5 GHz PA 101 to achieve optimal power transfer or throughput of the 5 GHz transmit signal via the 5 GHz transmit amplifier path 110. The capacitor C4 also acts as a bypass capacitor and prevents RF energy from coupling through the DC VCC power feed to the 5 GHz PA 101. The capacitor C5 provides DC blocking along with coupling to the 50 ohm stripline 106. The LPF 105 further attenuates frequencies above the 5 GHZ corner frequency including harmonic distortion energy. The diplexer 109 provides a low impedance coupling to the common 50 ohm output 140 for transmission of the 5 GHz transmit signal.

In the 2.45 GHZ transmit amplifier path 120, the output of the 2.45 GHz PA 103 is connected to both the stripline 104 and the trap circuit 130. The stripline 104 is similar design and function to the stripline 102 and has an impedance Z1. The impedances Z1 and Z2 may be the same or similar, or may each be tuned or otherwise configured for the respective frequency level of the transmit signal. The 2.45 GHz transmit amplifier path 120 also has the inductor L2 and the capacitor C3 adding load to the 2.45 GHz PA 103, similar to the inductor L3 and the capacitor C4 of the 5 GHz transmit amplifier path 110. The capacitor C3 also acts as a bypass capacitor in a similar manner as the capacitor C4. Without the trap circuit 130, the values of the complex impedance Z1 of the stripline 102, the inductance of the inductor L2, and the capacitance of the capacitor C3 would otherwise be selected to provide desired impedance loading for the output of the 2.45 GHz PA 103 to achieve optimal power transfer or throughput of the 2.45 GHz transmit signal for the 2.45 GHz transmit amplifier path 120 in a similar manner as described above for the 5 GHz transmit amplifier path 110. However, in the 2.45 GHz transmit amplifier path 120, the load of the capacitance of capacitor C1 and the inductance of the inductor L1 of the trap circuit 130 is considered along with the values of Z1, L2 and C3 to achieve the desired impedance loading. In one embodiment, the values of L2 and C3 are adjusted to compensate for the additional loading of the trap circuit 130 to achieve the desired loading for the 2.45 GHz PA 103.

The PA 103 is not ideal and performs nonlinear amplification resulting in a significant level of harmonic energy at its output when amplifying the 2.45 GHz input signal. In exemplary embodiments, the 2.45 and 5 GHz power amplifiers 101 and 103 are located in close proximity. In one embodiment, the 2.45 GHz PA 103 and 5 GHz PA 101 are provided within a single integrated circuit package 160 and may even be monolithically implemented on a single semiconductor die. Any harmonic energy generated by the 2.45 GHz PA 103 is otherwise radiated to the 5 GHz transmit amplifier path 110, such as via an exemplary harmonic coupling path 150. The second harmonic frequency of the amplified 2.45 GHz transmit signal is approximately 4.9 GHz, which is within an interfering frequency range of the 5 GHz transmit signal or otherwise within the passband frequency range of the 5 GHZ transmit amplifier path 110. Consequently, since the 5 GHz transmit amplifier path 110 is designed so that it provides low loss for energy in the 5 GHz passband frequency range, the second harmonic frequency of the amplified 2.45 GHz transmit signal (˜4.9 GHz) would otherwise be conducted with very little loss through the 5 GHz transmit amplifier path 110 and transmitted via the antenna. Such interference is undesirable and would otherwise cause the transmitter to fail necessary compliance harmonic specifications (e.g., those promulgated by FCC and/or ETSI).

The trap circuit 130 is configured to be resonant at approximately 4.9 GHz, thereby effectively shunting the second harmonic energy of the 2.45 transmit signal to ground. In this manner, the second harmonic energy generated by the 2.45 GHz PA 103 is shunted away and prevented from coupling to the 5 GHz transmit amplifier path 110. It may be desired to place the trap circuit 130 as close as possible to the physical output of the 2.45 GHz PA 103 to achieve maximum suppression of harmonic energy. In the embodiment shown, the trap circuit 130 is a tuned series LC circuit resonant at the second harmonic of 2.45 GHz signal. At 2.45 GHz, the tuned series LC circuit has a residual impedance that is primarily capacitive. The values of L2 and C3 are selected to combine with Z1 and the values of C1 and L1 to properly load the 2.45 GHz PA 103 to achieve optimum power output at 2.45 GHz. The values of C1 and L1 may be selected from among standard inductance and capacitance values that are readily available to avoid increased cost of non-standard components. In a specific embodiment, standard values of L1=3.3 nanohenries (nH) and C1=0.2 picofarads (pF) are employed for the trap circuit 130.

The trap circuit 130 is shown as an inductor and capacitor coupled in series, although other LC circuits are contemplated. In alternative embodiments, any filter circuit is contemplated that is configured to filter the harmonic energy of one transmission path that is within the passband of another transmission path. Also, the series coupling of L1 and C1 may be reversed such that the capacitor C1 is coupled to ground instead. Operation is substantially the same in the reversed configuration, although the inductor/capacitor component values might need to be adjusted to optimize functionality depending upon the particular configuration.

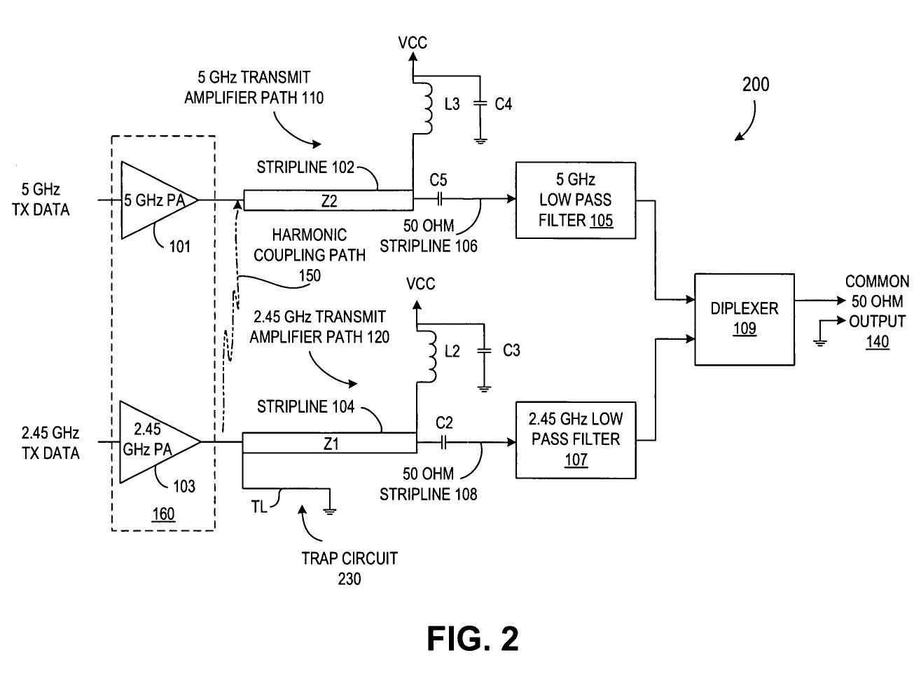

FIG. 2 is a simplified schematic diagram of a portion of a dual band wireless transmitter 200 similar to the dual band wireless transmitter 100 in which the trap circuit 130 is replaced with an alternative trap circuit 230. Similar components assume identical reference numerals. The trap circuit 230 is a transmission line TL having one end coupled to the output of the 2.45 GHz PA 103 and another end coupled or otherwise short-circuited to ground. The transmission line TL has a length which is approximately one-half (½) wavelength of the 2^{nd} harmonic frequency of the 2.45 GHz signal. At the fundamental frequency of the 2.45 GHz signal, the transmission line TL is one-quarter (¼) wavelength long and therefore appears as an open circuit.

Again, the values of the inductor L2 and the capacitor C3 are chosen to achieve the desired impedance loading for the 2.45 GHz transmit amplifier path 120. As compared to the trap circuit 130, the load of the series inductor L1 and capacitor is removed and replaced with the loading of the transmission line TL, which is considered in combination with the values of the inductor L2 and the capacitor C3. In one embodiment, the transmission line TL is a 50 ohm line, such as a 50 ohm strip line or the like. The loading of the transmission line TL may be relatively small as compared to the loading of the series tuned LC circuit of the trap circuit 130.

Although the present invention has been described in considerable detail with reference to certain preferred versions thereof, other versions and variations are possible and contemplated. Those skilled in the art should appreciate that they can readily use the disclosed conception and specific embodiments as a basis for designing or modifying other structures for providing out the same purposes of the present invention without departing from the spirit and scope of the invention as defined by the appended claims.

1. A multiple band transmitter, comprising:
a first transmit amplifier path conducting a first transmit signal at a first frequency band; and
a second transmit amplifier path conducting a second transmit signal at a second frequency band, said second transmit amplifier path comprising:
an amplifier that generates said second transmit signal and a harmonic frequency within a passband of said first transmit amplifier path; and
a trap circuit, coupled to an output of said amplifier, that shunts said harmonic frequency away from said first transmit amplifier path.

2. The multiple band transmitter of claim 1, wherein said trap circuit comprises a series LC circuit.

3. The multiple band transmitter of claim 2, wherein said series LC circuit is tuned to a second harmonic frequency of said second frequency band.

4. The multiple band transmitter of claim 2, wherein said series LC circuit comprises a load that cooperates with remaining portions of said second transmit amplifier path to optimize power throughput of said second transmit signal along said second transmit amplifier path.

5. The multiple band transmitter of claim 1, wherein said trap circuit comprises a transmission line.

6. The multiple band transmitter of claim 5, wherein said transmission line is tuned to a second harmonic frequency of said second frequency band.

7. The multiple band transmitter of claim 5, wherein said transmission line has a length which is approximately one-half wavelength of a second harmonic frequency of said second frequency band.

8. The multiple band transmitter of claim 1, wherein said first transmit amplifier path conducts said first transmit signal at a frequency band of approximately 5 gigahertz, and wherein said second transmit amplifier path conducts said second transmit signal at a frequency band of approximately 2.45 gigahertz.

9. The multiple band transmitter of claim 8, wherein said first and second transmit amplifier paths form a transmitter portion of a dual band wireless local area network transceiver.

10. A multiple band transmitter, comprising:
a plurality of amplifier paths, each amplifying a corresponding transmit signal at a corresponding frequency band;
said plurality of amplifier paths including a first amplifier path that generates a harmonic frequency within a passband of at least one other of said plurality of amplifier paths; and
a trap circuit, coupled to said first amplifier path, that shunts said harmonic frequency to ground.

11. The multiple band transmitter of claim 10, wherein said trap circuit comprises a series LC circuit.

12. The multiple band transmitter of claim 11, wherein said series LC circuit is tuned to said harmonic frequency.

13. The multiple band transmitter of claim 11, wherein said series LC circuit comprises a load that cooperates with remaining portions of said first amplifier path to optimize power throughput.

14. The multiple band transmitter of claim 10, wherein said trap circuit comprises a transmission line.

15. The multiple band transmitter of claim 14, wherein said transmission line is tuned to said harmonic frequency.

16. The multiple band transmitter of claim 14, wherein said transmission line has a length which is approximately one-half wavelength of said harmonic frequency.

17. The multiple band transmitter of claim 10, wherein said first amplifier path includes a power amplifier having an output that generates said harmonic frequency, and wherein said trap circuit is coupled at an output of said power amplifier.
